(19) United States
(12) Patent Application Publication
(10) Pub. No.: US 2026/0319785 A1
(43) Pub. Date: Oct. 15, 2026

(54) ELECTRONIC DEVICE AND UPDATING METHOD FOR ELECTRONIC DEVICE

(71) Applicant: JVCKENWOOD Corporation, Yokohama-shi (JP)

(72) Inventors: Rikiya Kasahara, Yokohama-shi (JP); Seiichi Tanno, Yokohama-shi (JP); Go Tamura, Yokohama-shi (JP); Toshiaki Nishida, Yokohama-shi (JP)

(21) Appl. No.: 19/685,140

(22) Filed: May 22, 2026

Related U.S. Application Data
(63) Continuation of application No. PCT/JP2024/042101, filed on Nov. 28, 2024.

(30) Foreign Application Priority Data
Dec. 21, 2023 (JP) 2023-215796

(51) Int. Cl. G06F 8/65; H04W 8/24

(52) U.S. Cl. CPC G06F 8/65; H04W 8/245

(57) ABSTRACT

When a single electronic device is selected and its computer program is updated, the computer programs of the other electronic devices can also be updated automatically. An electronic device includes: a determining unit that determines whether or not to update a computer program of the electronic device; an updating unit that, based on the determination result obtained by the determining unit, updates the computer program with an update program; and a communication unit that performs communication with another electronic device belonging to a group and that performs communication with an external device. When the determining unit determines that the computer program has not been updated with the update program, the updating unit updates the computer program either with the update program obtained by the communication unit from the external device or with the update program received by the communication unit. After the updating unit updates the computer program, the communication unit sends the update program to the other electronic device belonging to the group.

### CROSS-REFERENCE TO RELATED APPLICATIONS

This application is a Continuation of PCT International Application No. PCT/JP2024/042101 filed on Nov. 28, 2024 which claims the benefit of priority from Japanese Patent Application No. 2023-215796, filed on Dec. 21, 2023, the entire contents of both of which are incorporated herein by reference.

### BACKGROUND OF THE INVENTION

### 1. Field of the Invention

The application concerned is related to an electronic device and an updating method for the electronic device.

### 2. Description of the Related Art

In Japanese Patent Application Laid-open No. 2015-46075 is disclosed a technology by which the software stored in an external storage device and the setting values corresponding to that software can be installed in an information processing device.

In the technology disclosed in Japanese Patent Application Laid-open No. 2015-46075, when a computer program is to be installed/updated in information processing devices from an external storage device (an external device); the external device is connected to each information processing device and the computer program is installed/updated. However, that is a time consuming task. Moreover, when an information processing device (an electronic device) is present indoors or outdoors, the external device needs to be taken to the outdoors, thereby requiring time and efforts.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

An electronic device according to the present disclosure comprising: a determining unit that determines whether or not to update a computer program of the electronic device; an updating unit that, based on determination result obtained by the determining unit, updates the computer program with an update program; and
a communication unit that performs communication with another electronic device belonging to a group and that performs communication with an external device, wherein
when the determining unit determines that the computer program has not been updated with the update program, the updating unit updates the computer program either with the update program obtained by the communication unit from the external device or with the update program received by the communication unit, and after the updating unit updates the computer program, the communication unit sends the update program to the other electronic device belonging to the group.

An updating method for an electronic device according to the present disclosure, comprising: determining whether or not to update a computer program of the electronic device; updating, based on determination result obtained at the determining, the computer program with an update program; and communicating with another electronic device belonging to a group and with an external device, wherein when it is determined at the determining that the computer program has not been updated with the update program, the updating includes updating the computer program either with the update program obtained at the communicating from the external device or with the update program received at the communicating from another electronic device, and after the computer program is updated at the updating, the communicating includes sending the update program to the other electronic device belonging to the group.

### BRIEF DESCRIPTION OF THE DRAWINGS

FIG. 1 is a diagram for explaining a configuration of a communication system according to a first embodiment;

FIG. 2 is a block diagram illustrating an exemplary configuration of an electronic device according to the first embodiment;

FIG. 3 is a sequence diagram illustrating an example of a communication operation performed by the electronic device according to the first embodiment;

FIG. 4 is a flowchart for explaining an exemplary flow of operations performed in the electronic device that obtains an update program according to the first embodiment;

FIG. 5 is a flowchart for explaining an exemplary flow of operations performed in the electronic device that receives an update program according to the first embodiment;

FIG. 6 is a diagram for explaining a configuration of a communication system according to a second embodiment;

FIG. 7 is a sequence diagram illustrating an example of a communication operation performed by an electronic device according to the second embodiment;

FIG. 8 is a flowchart for explaining an exemplary flow of operations performed in the electronic device that receives an update program according to the second embodiment;

FIG. 9 is a diagram for explaining a configuration of a communication system according to the third embodiment;

FIG. 10 is a sequence diagram illustrating an example of a communication operation performed by an electronic device according to the third embodiment;

FIG. 11 is a flowchart for explaining an exemplary flow of operations performed in the electronic device that obtains an update program according to the third embodiment; and

FIG. 12 is a flowchart for explaining an exemplary flow of operations performed in the electronic device that receives an update program according to the third embodiment.

### DETAILED DESCRIPTION OF THE PREFERRED EMBODIMENTS

Exemplary embodiments of the application concerned are described in detail with reference to the accompanying drawings. However, the application concerned is not limited by the embodiments described below. Moreover, the constituent elements explained in the embodiments include the constituent elements that are simple and are replaceable by a person skilled in the art, or include practically identical constituent elements.

### First embodiment

Communication system

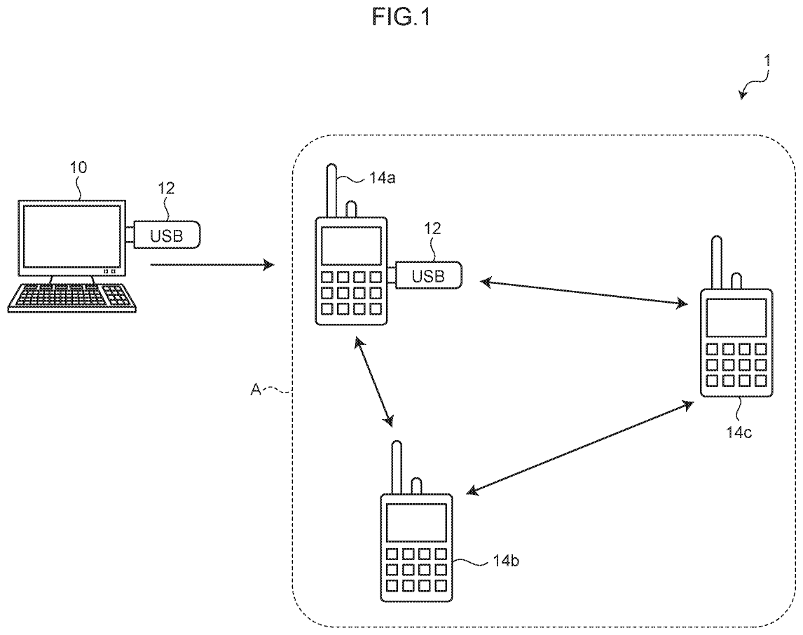

FIG. 1 is a diagram for explaining a configuration of a communication system according to a first embodiment.

As illustrated in FIG. 1, a communication system 1 includes a management device 10, an external device 12, and electronic devices 14a, 14b, and 14c. Thus, the communication system 1 includes the management device 10, the external device 12, and a plurality of electronic devices 14. The electronic devices 14a to 14c belong to a group A. Moreover, the electronic devices 14a to 14c are positioned within a predetermined range (for example, from a few kilometers to a few tens of kilometers), and perform group communication with each other. There is no restriction on the locations at which the electronic devices 14a to 14c are positioned. For example, all electronic devices can be positioned indoors or outdoors, or only some of the electronic devices can be positioned indoors or outdoors. In FIG. 1, for explanatory convenience, three electronic devices 14a to 14c are illustrated as the electronic devices 14. However, there can be more than three electronic devices 14. The group A represents a first group. When no particular group is specified, simply the term “group” is used.

In the communication system 1, an external device 12 in which an update program A meant for the electronic devices 14 belonging to the group A is stored is connected to one electronic device (for example, the electronic device 14a). The electronic device 14a obtains the update program from the external device 12, and updates the computer program stored therein with the update program A. Then, the electronic device 14a sends the update program A to the electronic devices 14b and 14c using group communication. After the electronic devices 14b and 14c receive the update program A using group communication, the computer programs already stored therein are updated automatically with the update program A. Once the computer programs stored in the electronic devices 14b and 14c are updated with the update program A, the update program A is sent to the other electronic devices belonging to the group A using group communication. That is, in the communication system, as a result of updating the computer program in one electronic device, the computer programs in the other electronic devices belonging to the same group can be updated automatically. Meanwhile, it is desirable that the update program is compatible to the electronic devices belonging to the group. For example, the update program is compatible to the electronic devices 14 belonging to the group A. Meanwhile, the update program need not be a singular update program, and can include a plurality of update programs. That enables updating of computer programs corresponding to a plurality of functions of the electronic devices 14. Moreover, the update program can be the setting data of the electronic devices 14. Examples of the update program include, a firmware update program, FPU data (FPU stands for Field Programming Unit), and a license update program.

### Management Device

The management device 10 manages the electronic devices 14 in the communication system 1. For example, the management device 10 manages the communication performed by the electronic devices 14. The management device 10 stores an update program in the external device 12. At the time of storing an update program in the external device 12, the management device 10 can encrypt the update program. In that case, the management device 10 writes a decryption file, which enables decryption of an encrypted file, in the electronic device 14 to which the external device 12 would be connected. The management device 10 is, for example, an information processing device such as a computer.

### External Device

The external device 12 is a data storage device that can be connected externally to the management device 10 and the electronic devices 14. For example, the external device 12 stores therein the update program written for the electronic devices 14. The external device 12 is connected to the management device 10, so that the update program written for the electronic devices 14 is stored from the management device 10 in the external device 12. The external device 12 is, for example, a USB memory (USB stands for Universal Serial Bus).

### Electronic Device

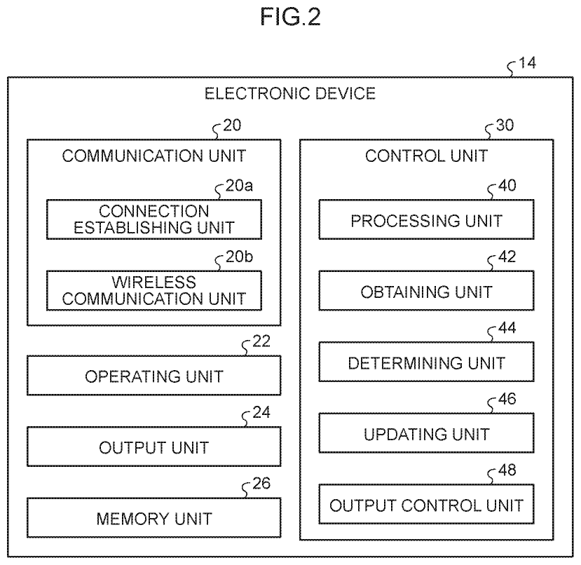

Explained below with reference to FIG. 2 is the electronic device 14. FIG. 2 is a block diagram illustrating an exemplary configuration of the electronic device according to the first embodiment. The electronic device 14 is implemented using a portable communication device such as a commercial-grade transceiver or a smartphone. In the application concerned, the electronic device 14 is a transceiver.

As illustrated in FIG. 2, the electronic device 14 includes a communication unit 20, an operating unit 22, an output unit 24, a memory unit 26, and a control unit 30.

The communication unit 20 includes a connection establishing unit 20a and a wireless communication unit 20b. The connection establishing unit 20a reads data from and writes data into the external device 12. The connection establishing unit 20a includes, for example, the connector of the USB memory. When the control unit 30 detects a connection with the external device 12, the connection establishing unit 20a performs communication with the external device 12. The wireless communication unit 20b of the communication unit 20 performs communication with the electronic devices 14. The wireless communication unit 20b performs wireless communication with the other electronic devices belonging to the same group. The wireless communication unit 20b sends a variety of information to the other electronic devices and receives a variety of information from the other electronic devices. Meanwhile, there is no particular restriction on the type of data that can be communicated by the communication unit 20 with the other electronic devices and the external device 12. For example, the communication unit 20 communicates an update program. When an updating unit 46 (explained later) updates the computer program, the wireless communication unit 20b sends the update program to the other electronic devices. The wireless communication unit 20b can have the function of near field communication, or can have the function of long-range wireless communication. The communication unit 20 is configured using a communication circuit.

The operating unit 22 receives a variety of input operations performed with respect to the electronic devices 14. The operating unit 22 outputs, to the control unit 30, an input signal according to the received input operation. Examples of the operating unit 22 include a touch-sensitive panel, a button, a switch, a microphone, and a PTT button (PTT stands for Push to Talk).

The output unit 24 outputs a variety of data. For example, the output unit 24 displays the downloading of the update program and displays the installation information. The output unit 24 outputs, for example, the voices of the users of the other electronic devices 14. For example, the output unit 24 can be a display such as a liquid crystal display (LCD) or an electro-luminescence (EL) display, or can be a speaker.

The memory unit 26 stores therein a variety of information. The memory unit 26 stores therein the information about the electronic devices 14. For example, the memory unit 26 stores therein the IDs (identifiers) for the electronic devices 14. The ID for each electronic device 14 includes an ID (terminal ID) assigned to that electronic device 14 and an ID assigned to the group to which the electronic device 14 belongs, that is, an ID (group ID) assigned on a group-by-group basis. The memory unit 26 stores therein a decryption file that enables decryption. Moreover, the memory unit 26 stores therein the information such as the operation details of the control unit 30 and computer programs. Furthermore, the memory unit 26 stores therein the update program that is stored in the external device 12. For example, the memory unit 26 includes at least either a main storage device such as a random access memory (RAM) and a read only memory (ROM), or an external storage device such as a hard disk drive (HDD).

The control unit 30 controls the constituent elements of the electronic device 14. For example, the control unit 30 includes an information processing device such as a central processing unit (CPU) or a micro processing unit (MPU). Alternatively, for example, the control unit 30 can be implemented using an integrated circuit such as an application specific integrated circuit (ASIC) or a field programmable gate array (FPGA). Still alternatively, the control unit 30 can be implemented using a combination of hardware and software.

The control unit 30 includes a processing unit 40, an obtaining unit 42, a determining unit 44, an updating unit 46, and an output control unit 48.

The processing unit 40 performs a variety of operations of the electronic device 14. For example, the processing unit 40 determines whether the external device 12 is connected. When it is detected that the electronic device 14 is connected to the external device 12, the processing unit 40 confirms with the user about whether to execute an update program. For example, when the update program is encrypted, the processing unit 40 performs decryption. For that, the processing unit 40 reads a decryption file from the memory unit 26 and decrypts the encrypted update program. For example, the processing unit 40 implements the update feature provided in the electronic device 14. Moreover, the processing unit 40 can generate a message for the user. For example, when the update program is not compatible to the external device 12 that is connected to the electronic device 14, the processing unit 40 generates a message indicating that the update program is not compatible.

The obtaining unit 42 obtains the update program stored in the electronic device 14. When the external device 12, in which the update program for the group to which the concerned electronic device belongs is stored, is connected to the connection establishing unit 20a of the communication unit 20, the obtaining unit 42 obtains the update program from the external device 12. Then, the obtaining unit 42 outputs the update program to the memory unit 26.

The determining unit 44 performs various determination operations with respect to the electronic device 14. For example, the determining unit 44 determines whether or not to update the computer program meant for operating the control unit 30 of the electronic device 14. For example, the determining unit 44 determines whether or not the communication unit 20 of the electronic device 14 has obtained the update program. For example, the determining unit 44 determines whether or not the computer program of the electronic device 14 has already been updated. Moreover, for example, the determining unit 44 determines the communication frequency of the electronic device 14.

The updating unit 46 updates the computer program, which is stored in the electronic device 14, with the update program. When the determining unit 44 determines that the computer program of the electronic device 14 has not been updated, the updating unit 46 updates the current computer program with the update program obtained by the communication unit 20 from the external device 12. Thus, when the determining unit 44 determines that the computer program of the electronic device 14 has not been updated, the updating unit 46 updates the current computer program with the update program obtained by the communication unit 20 of the concerned electronic device 14 from another electronic device. The updating unit 46 overwrites the pre-updating computer program with the update program and thus updates the current computer program. Once the computer program of the electronic device 14 is updated with the update program, even when the same update program is obtained, the updating unit 46 does not update the computer program.

The output control unit 48 outputs a variety of data of the electronic device 14 to the output unit 24. For example, the output control unit 48 outputs the voice data of the user, which is received as a result of wireless communication performed between another electronic device and the communication unit 20, and causes the output unit 24 to output a voice. The output control unit 48 causes the output unit 24 to display the progress in the updating of the electronic device 14 with the update program.

### Communication Operation

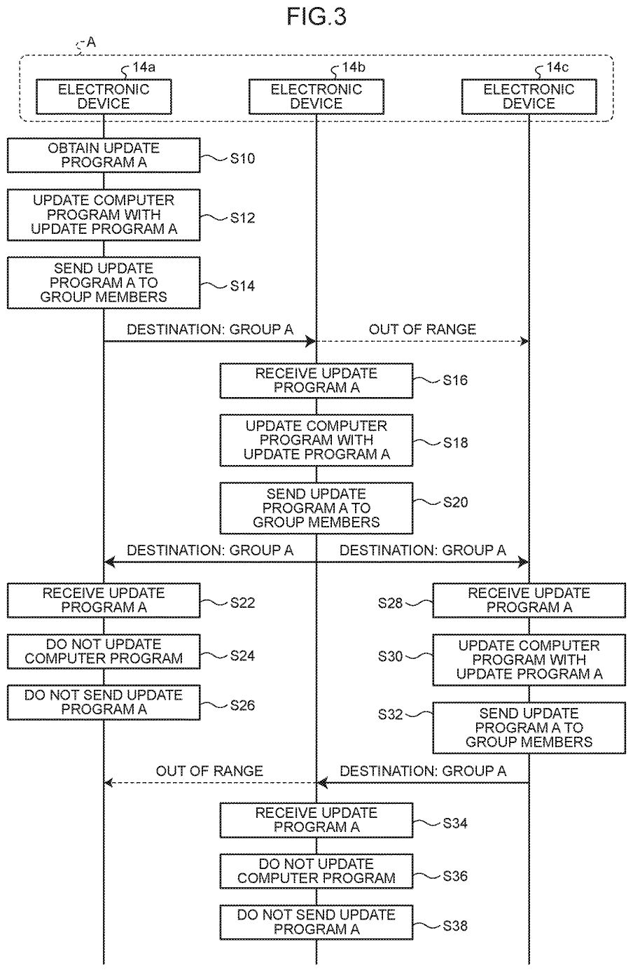

Given below is the explanation about a computer operation performed by the electronic device 14 according to the first embodiment. FIG. 3 is a sequence diagram illustrating an example of a communication operation performed by the electronic device according to the first embodiment. For explanatory convenience, in FIG. 3 is illustrated an example in which the electronic device 14a obtains the update program A from the external device 12. Alternatively, either the electronic device 14b or the electronic device 14c can obtain the update program A from the external device 12.

With reference to FIG. 3, the electronic device 14a has the external device 12 connected to and obtains the update program from the external device 12. The electronic devices 14b and 14c receive the update program using wireless communication.

The obtaining unit 42 of the electronic device 14a obtains the update program A from the external device 12 (Step S10). When the update program A is encrypted, the processing unit 40 of the electronic device 14a decrypts the update program A.

The updating unit 46 of the electronic device 14a updates the computer program of the electronic device 14a with the update program A (Step S12). Then, the updating unit 46 of the electronic device 14a overwrites the computer program of the electronic device 14a with the update program A, which is obtained by the obtaining unit 42 of the electronic device 14a, thereby resulting in automatic updating.

The communication unit 20 of the electronic device 14a sends the update program A to the other electronic devices belonging to the same group A (Step S14). In the signals of wireless communication, for example, the information about the terminal ID or the group ID indicating the communication destination is included, and the electronic device 14 that receives the signals of wireless communication determines whether or not the signals are addressed to it. More particularly, in order to send the update program A to the electronic devices 14a and 14c, the communication unit 20 of the electronic device 14a sends the signals that include the information about the group ID of the group A as the destination.

The communication unit 20 of the electronic device 14b receives the update program A sent from the electronic device 14a (Step S16). In the example illustrated in FIG. 3, the electronic device 14c is in the state of not being able to receive the update program A from the electronic device 14a due to poor reception caused by obstacles or jamming signals.

The updating unit 46 of the electronic device 14b updates its computer program with the update program A received from the electronic device 14a (Step S18). The updating unit 46 of the electronic device 14b overwrites the computer program of the electronic device 14b with the update program A received by the communication unit 20 of the electronic device 14b from the electronic device 14a, and thus updates the computer program.

The communication unit 20 of the electronic device 14b sends the update program A to the other electronic devices belonging to the same group A (Step S20). More particularly, in order to send the update program A to the electronic devices 14a and 14c, the communication unit 20 of the electronic device 14b sends the signals that include the information about the group ID of the group A as the destination.

The communication unit 20 of the electronic device 14a receives the update program A sent from the electronic device 14b (Step S22).

However, the updating unit 46 of the electronic device 14a does not update the computer program of the electronic device 14a (Step S24). Since that computer program has already been updated with the update program A, the updating unit 46 of the electronic device 14a does not update the computer program with the update program A received from the electronic device 14b.

Moreover, the communication unit 20 of the electronic device 14a does not send the update program A to the other electronic devices (Step S26). More particularly, since the computer program of the electronic device 14a has already been updated with the update program A, the communication unit 20 of the electronic device 14a does not send the update program to the electronic devices 14b and 14c belonging to the same group A.

The communication unit 20 of the electronic device 14c receives the update program A sent from the electronic device 14b (Step S28).

The updating unit 46 of the electronic device 14c updates its computer program with the update program A (Step S30). The updating unit 46 of the electronic device 14b overwrites the computer program of the electronic device 14c with the update program A received by the communication unit 20 from the electronic device 14b, and thus updates the computer program.

The communication unit 20 of the electronic device 14c sends the update program A to the other electronic devices (Step S32). More particularly, the communication unit 20 of the electronic device 14c sends the update program A to the electronic devices 14a and 14b belonging to the same group A.

The electronic device 14b receives the update program A (Step S34). Thus, the communication unit 20 of the electronic device 14b receives the update program A sent from the electronic device 14c. In the example illustrated in FIG. 3, the electronic device 14a is in the state of not being able to receive the update program A from the electronic device 14c due to poor reception.

The updating unit 46 of the electronic device 14b does not update the computer program of the electronic device 14b (Step S36). Since that computer program has already been updated with the update program A, the updating unit 46 of the electronic device 14b does not update the computer program with the update program A received from the electronic device 14c.

The communication unit 20 of the electronic device 14b does not send the update program A to the other electronic devices (Step S38). More particularly, since the computer program of the electronic device 14b has already been updated with the update program A, the communication unit 20 of the electronic device 14b does not send the update program to the electronic devices 14a and 14c belonging to the same group A.

### Operations Performed in Electronic Device

Given below is the explanation about the electronic device 14 according to the first embodiment.

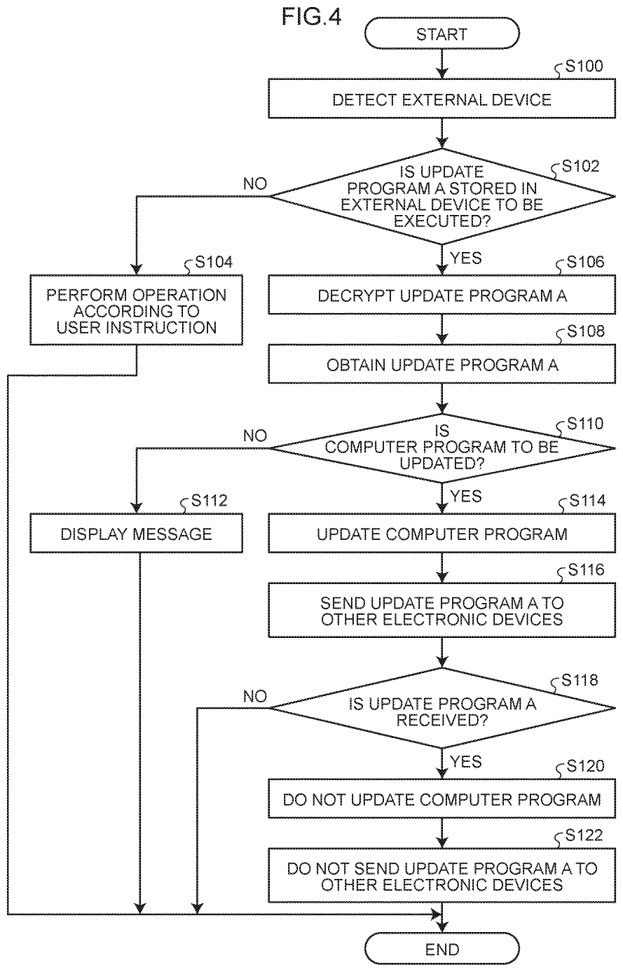

Firstly, the explanation is given about the operations performed in the electronic device 14a that obtains the update program from the external device 12. FIG. 4 is a flowchart for explaining an exemplary flow of operations performed in the electronic device that obtains the update program according to the first embodiment.

The processing unit 40 has the external device 12 connected thereto, and detects the update program A stored in the external device 12 (Step S100).

The processing unit 40 determines whether or not to execute the update program A stored in the external device 12 (Step S102). More specifically, the processing unit 40 confirms with the user about whether to execute the update program A stored in the external device 12. For example, the processing unit 40 displays a message on the output unit 24 and confirms with the user about whether to execute the update program A.

When the update program A stored in the external device 12 is not to be executed, that is, when the user chooses not to execute the update program A (No at Step S102), the processing unit 40 performs an operation according to the user instruction (Step S104) and ends the operations regarding the update program A stored in the external device 12. For example, the operation according to the user instruction indicates continuing with the operation that was being performed prior to the connection of the external device 12.

When the update program A stored in the external device 12 is to be executed, that is, when the user chooses to execute the update program A (Yes at Step S102), the processing unit 40 decrypts the update program A (Step S106). When the update program A is not to be decrypted, the processing unit 40 performs the operation at Step S108.

The obtaining unit 42 obtains the decrypted update program A (Step S108). Then, the obtaining unit 42 outputs the update program A to the memory unit 26 of the electronic device 14a.

The determining unit 44 determines whether to update the computer program of the electronic device 14a (Step S110). The determining unit 44 determines whether or not the update program A stored in the external device 12 is compatible, that is, whether or not the update program A stored in the external device 12 is valid, and accordingly determines whether to update the computer program of the electronic device 14a.

When it is determined not to update the computer program of the electronic device 14a (No at Step S110), the processing unit 40 generates a message indicating that the computer program of the electronic device 14a is not to be updated and displays the message in the output unit 24 (Step S112). That marks the end of the operations. For example, the processing unit 40 can generate a message such as “incompatible update program”. The case in which the computer program of the electronic device 14a is not to be updated is, for example, the case in which the update program A becomes invalid when decrypted.

When it is determined that the computer program of the electronic device 14a is to be updated (Yes at Step S110), the updating unit 46 overwrites the computer program of the electronic device 14a, thereby resulting in automatic updating (Step S114). At that time, the processing unit 40 implements the update function provided in the electronic device 14a.

The communication unit 20 sends the update program A to the other electronic devices using the wireless communication unit 20b (Step S116). More specifically, the communication unit 20 reads the update program A from the memory unit 26 and sends it to the other electronic devices, which belong to the same group A, using wireless communication. The communication unit 20 sends the update program A addressed to the group ID stored in the other electronic devices. For example, the communication unit 20 sends the update program A to the electronic devices 14b and 14c in which the stored group ID (the ID of a first group) is same as the group ID stored in the electronic device 14a. Alternatively, the communication unit 20 can send the update program A to the other electronic devices based on their terminal IDs.

The determining unit 44 determines whether the communication unit 20 has received the update program A using the wireless communication unit 20b (Step S118). When the determining unit 44 determines that the communication unit 20 has not received the update program A (No at Step S118), it marks the end of the operations.

Even when the determining unit 44 determines that the communication unit 20 has received the update program A (Yes at Step S118), neither the updating unit 46 updates the computer program (Step S120) nor the communication unit 20 sends the update program A to the other electronic devices using the wireless communication unit 20b (Step S122). It marks the end of the operations.

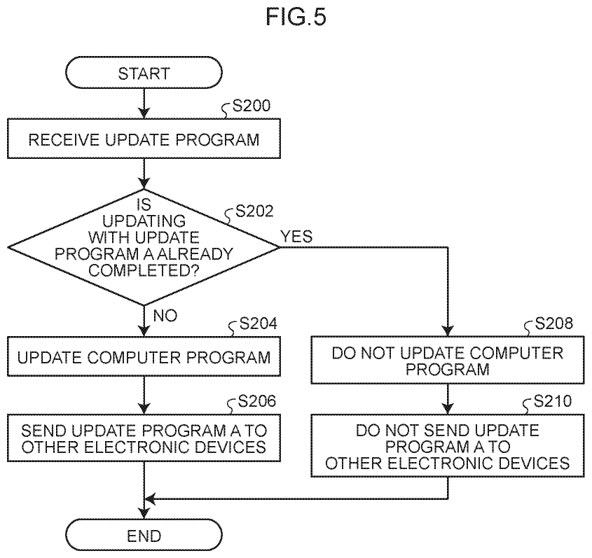

Given below is the explanation about the operations performed in the electronic devices 14b and 14c to which the external device 12 is not connected and which receive the update program using the corresponding wireless communication unit 20b of the communication unit 20. The electronic devices 14b and 14c perform identical operations. In the application concerned, the explanation is given about the operations performed by the electronic device 14b. FIG. 5 is a flowchart for explaining an exemplary flow of operations performed in the electronic device that receives the update program according to the first embodiment.

The communication unit 20 receives the update program A sent from the electronic device 14a (Step S200). At that time, when the data received by the wireless communication unit 20b of the communication unit 20 represents the update program, the processing unit 40 implements the update function provided in the electronic device 14b.

The determining unit 44 determines whether or not the computer program being currently used in the electronic device 14b has already been updated with the update program A (Step S202). When the determining unit 44 determines that the computer program of the electronic device 14b has not been updated with the update program A (No at Step S202), the system control proceeds to Step S204. The operations performed at Steps S204 and S206 are identical to the operations performed at Steps S114 and S116, respectively, performed by the electronic device 14a as illustrated in FIG. 4. Hence, that explanation is not given again.

When the determining unit 44 determines that the computer program of the electronic device 14b has been updated with the update program A (Yes at Step S202), the system control proceeds to Step S208. The operations performed at Steps S208 and S210 are identical to the operations performed at Steps S120 and S122, respectively, performed by the electronic device 14a, respectively.

As explained above, in the application concerned, after the computer program is updated, the corresponding electronic device (for example, the electronic device 14b) sends the update program to the other electronic devices belonging to the same group. For that reason, an electronic device in which the computer program has once been updated (for example, the electronic device 14a) again receives the same update program. In that case, neither updating is performed nor the update program is sent ahead. In this way, the update program is transferred from the electronic devices located at different positions. Hence, for example, even the electronic device 14c that is located at a position out of range for the radio signals transferred by the electronic device 14a becomes able to receive the update program from the electronic device 14b that is within range. Hence, all electronic devices belong to the same group become able to complete the updating operation one by one.

As explained above, regarding the electronic devices 14 according to the first embodiment, any one electronic device that belongs to the group A (in the application concerned, the electronic device 14a) obtains the update program A from the external device 12 and updates its own computer program with the update program A. After the computer program of the electronic device 14a is updated with the update program A, the electronic device 14a sends the update program A to the other electronic devices 14b and 14c belonging to the same group A. The electronic devices 14b and 14c receive the update program from the electronic device 14a in a direct or indirect manner; update their own computer programs with the update program A; and then send the update program A to the other electronic devices 14 belonging to the group A. Hence, as a result of connecting the external device 12 only to a single electronic device, it becomes possible to update the computer programs of all electronic devices belonging to the same group. That enables eliminating the time and efforts required to connect the external device 12 to each electronic device.

Meanwhile, regardless of the fact that other electronic devices have completed updating their computer programs, an electronic device (in the application concerned, the electronic device 14b) still sends (transfers) the update program to the other electronic devices. For that reason, even when any electronic device (in the application concerned, the electronic device 14c) is not able to receive the update program first time around (i.e., when the electronic device 14a sends the update program A), it receives the update program A when transferred by the electronic device 14b. Hence, even when the update program could not be received first time around, the electronic device 14c can receive the update program A and update its computer program with the update program A.

In the first embodiment, regardless of the fact that the other electronic devices have completed updating their computer programs, an electronic device still sends (transfers) the update program to the other electronic devices. For that reason, even after an electronic device updates its computer program with the update program A, it again receives the update program A. In that case, the electronic device neither updates its computer program with the re-received update program A nor transfer that update program A to the other electronic devices. As a result, the operation of updating the computer program with the update program A gets completed in all electronic devices one by one, and the transfer of the update program A is not repeated endlessly.

### Second Embodiment

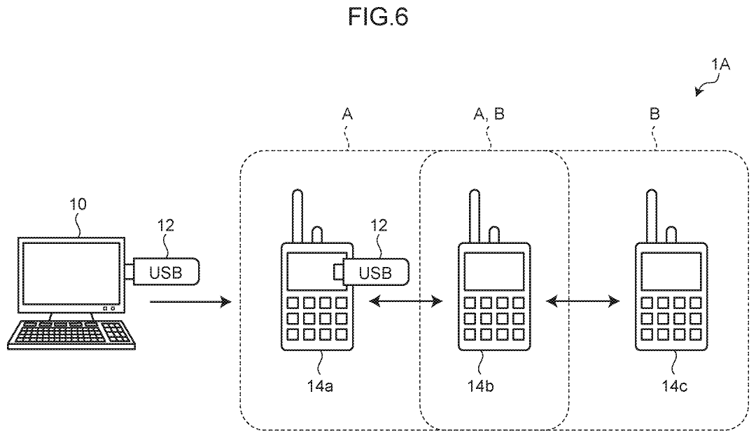

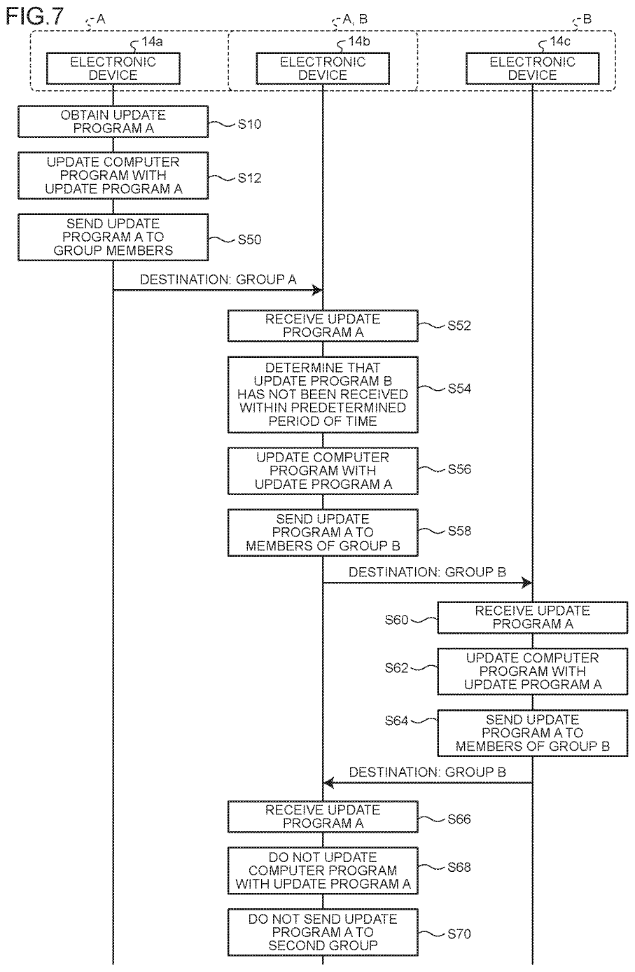

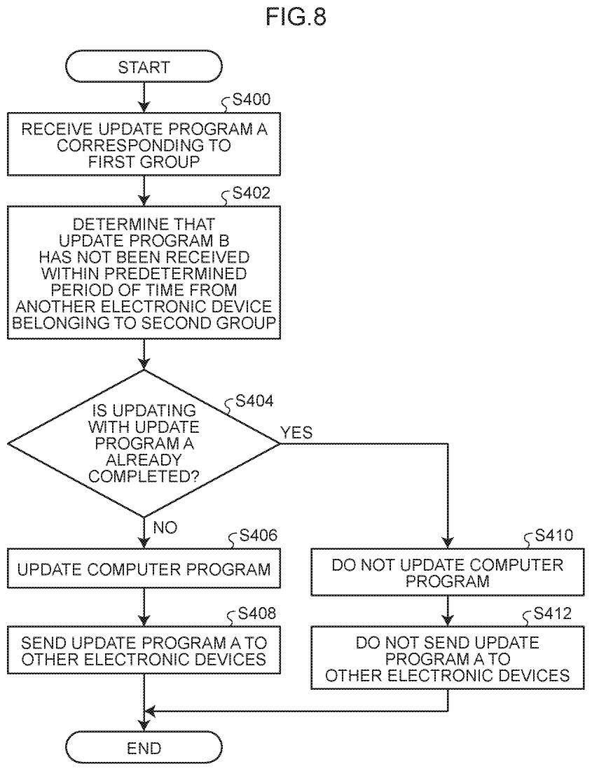

Explained below with reference to FIGS. 6 to 8 is a communication system 1A according to a second embodiment. FIG. 6 is a diagram for explaining a configuration of the communication system according to the second embodiment. FIG. 7 is a sequence diagram illustrating an example of a communication operation performed by an electronic device according to the second embodiment. FIG. 8 is a flowchart for explaining an exemplary flow of operations performed in the electronic device that receives the update program according to the second embodiment. In the following explanation, the identical constituent elements to the communication system 1 according to the first embodiment are referred to by the same reference numerals, and their detailed explanation is not given again. In the second embodiment, the fundamental configuration of the communication system 1A is identical to the communication system 1 according to the first embodiment. However, the second embodiment differs from the first embodiment in the way that the electronic devices 14 belong to a plurality of groups.

### Communication System

The communication system 1A includes the management device 10, the external device 12, and the electronic devices 14a, 14b, and 14c. More particularly, the communication system 1A differs the communication system 1 illustrated in FIG. 1 in the way that the electronic devices 14a and 14b belong to the group and the electronic devices 14b and 14c belong to a group B. Thus, the electronic device 14b belongs to two groups A and B. There can be two or more groups. For example, the electronic device 14b can belong to groups C and D. The group B represents a second group.

The electronic device 14a updates its computer program with the update program A obtained from the external device 12, and then sends the update program A to the electronic device 14b that belongs to the groups A and B. The electronic device 14b automatically updates its computer program with the update program A received from the electronic device 14a, and then sends the update program A to the electronic device 14c belonging to the group B. At that time, the electronic device 14b can send the update program A also to the electronic devices 14 belonging to the group A. Upon receiving the update program A from the electronic device 14b, the electronic device 14c automatically updates its computer program with the update program A, and then sends the update program A to the other electronic devices belonging to the group B. Thus, in the communication system 1A, when one electronic device updates its computer program, the update program can be sent to the electronic devices belonging to different groups, so that the computer programs of those electronic devices can be automatically updated. However, in the communication system 1A, it is assumed that an update program B, which corresponds to the electronic devices 14 belonging to the group B, is neither obtained by the electronic devices 14 belonging to the group B nor communicated among them.

Herein, the update from A corresponds to the electronic devices belonging to the group A, but can also include an update program for the electronic devices belonging to the group B. That is, the update program A can include an update program common for the electronic devices belonging to the group A and the electronic devices belonging to the group B. As a result, after one electronic device is updated, even if the other electronic devices belong to different groups, the common update program across the groups can be used to update the computer programs of the electronic devices belonging to different groups.

### Communication Operation

Explained below with reference to FIG. 7 is a communication operation performed in the electronic devices 14 according to the second embodiment. In FIG. 7 is illustrated an example in which the electronic device 14a obtains the update program A from the external device 12.

With reference to FIG. 7, the electronic device 14a has the external device 12 connected thereto, and obtains the update program from the external device 12. The electronic devices 14b and 14c receive the update program.

The operations performed at Steps S10, S12, and S50 are identical to the operations performed at Steps S10, S12, and S14 illustrated in FIG. 3. Hence, that explanation is not given again. Meanwhile, at Step S50, since the electronic device 14c belongs only to the second group, it does not receive the update program sent by the communication unit 20 of the electronic device 14a. The operation performed at Step S52 is identical to the operation performed at Step S16 illustrated in FIG. 3. Hence, that explanation is not given again.

The determining unit 44 of the electronic device 14b determines that the update program B has not been received within a predetermined period of time (Step S54). The determining unit 44 of the electronic device 14b determines that, the update program B corresponding to the electronic devices belong to the group B has not been received since receiving the update program A in the electronic device 14b. In the application concerned, the predetermined period of time is approximately between one to three days by taking into account the time required for all electronic devices in a group to sequentially receive the update program. That is, the electronic device 14b has not received the update program B within three days. At that time, although not illustrated, the processing unit 40 of the electronic device belonging to the group B (i.e., the electronic device 14c) can switch to the operation of updating its computer program with the update program corresponding to the group A. For example, the communication unit 20 of the electronic device 14b sends, to the electronic device 14c, information indicating that the update program A was received but the update program B has not been received. Based on the information indicating that the update program A sent from the electronic device 14b was received but the update program B has not been received, the processing unit 40 of the electronic device 14c switches the operation. As a result, even when the update program corresponding to another group is received, the electronic device 14 belonging to a different group becomes able to update its computer program with that update program.

The operations performed at Steps S56 and S58 are identical to the operations performed at Steps S18 and S20 illustrated in FIG. 3. Hence, that explanation is not given again. Meanwhile, at Step S58, the communication unit 20 of the electronic device 14b sends the update program to the group members (the other electronic devices) of the group B.

The operations performed from Step S60 to Step S64 are identical to the operations performed from Step S28 to Step S32. Hence, that explanation is not given again. Meanwhile, at Step S64, the communication unit 20 of the electronic device 14c transfers the update program A to the group members of the group B.

The operations performed from Step S66 to Step S70 are identical to the operations performed from Step S34 to Step S38 illustrated in FIG. 3. Hence, that explanation is not given again. Meanwhile, at Step S70, the communication unit 20 of the electronic device 14b sends the update program A neither to the group members (the other electronic devices) of the group B not to the group members (the other electronic devices) of the group A.

### Operations Performed in Electronic Device

Given below is the explanation about the operations performed in the electronic device according to the second embodiment. The operations performed in the electronic device 14a are identical to the operations performed from Step S100 to Step S122. Hence, that explanation is not given again.

The operations performed in the electronic device 14b are explained with reference to FIG. 8. In FIG. 8, the operation performed at Step S400 is identical to the operation at Step S200 illustrated in FIG. 5. Hence, that explanation is not given again.

The determining unit 44 of the electronic device 14b determines that the update program B has not been received within a predetermined period of time since receiving the update program A (Step S402). The determining unit 44 of the electronic device 14b determines that the communication unit 20 has not received the update program B, which corresponds to the group B, within a predetermined period of time from another electronic device belonging to the group B (for example, the electronic device 14c).

The operation performed at Step S404 is identical to the operation performed at Step S202 illustrated in FIG. 5. Hence, that explanation is not given again.

The updating unit 46 of the electronic device 14b updates the computer program of the electronic device 14b with the update program A (Step S406). The updating unit 46 of the electronic device 14b overwrites the computer program of the electronic device 14b, thereby resulting in automatic updating. When the communication unit 20 of the electronic device 14b receives the update program A from another electronic device belonging to the group A to which the electronic device 14b also belongs, the updating unit 46 of the electronic device 14b performs automatic updating with the received update program A. At that time, the processing unit 40 implements the update function provided in the electronic device 14b.

Except for having a different destination for the update program A, the operations performed from Step S408 to Step S412 are identical to the operations performed from Step S206 to Step S210. Hence, that explanation is not given again. Meanwhile, in the second embodiment, the destination to which the electronic device 14b sends the update program A are the other electronic devices belonging to the same group B to which the electronic device 14b also belongs. However, since the electronic device 14b also belongs to the group A, the update program A can be sent also to the other electronic devices belonging to the group A.

Although there is no drawing for reference, the electronic device 14c receives the update program from the electronic device 14b, performs the operations from Step S400 to Step S410 illustrated in FIG. 8, and ends the operations.

As explained above, the electronic devices 14 according to the second embodiment belong to a plurality of groups. In the second embodiment, the electronic device 14b belongs to two groups. Hence, when the update program B corresponding to the group B is not received, any electronic device belonging to a different group (for example, the electronic device 14c) becomes able to receive the update program A via the electronic device 14b. Then, the electronic device 14c switches to the operation of enabling the processing unit 40 thereof to perform updating with the update program A. Hence, the electronic device 14c too becomes able to update its computer program with the update program A. Moreover, since the electronic device 14b belongs to a plurality of groups, the electronic device 14a can send the update program A also to the electronic device 14c belonging to a different group. Hence, as a result of connecting the external device 12 only to a single electronic device, it becomes possible to update the computer programs of the electronic devices across a plurality of groups. That enables eliminating the time and efforts required to connect the external device 12 to an electronic device belonging to each group.

### Third Embodiment

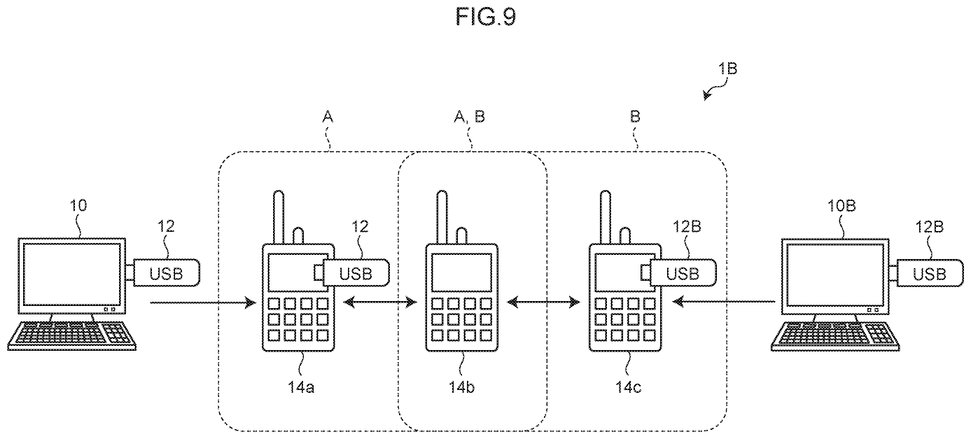

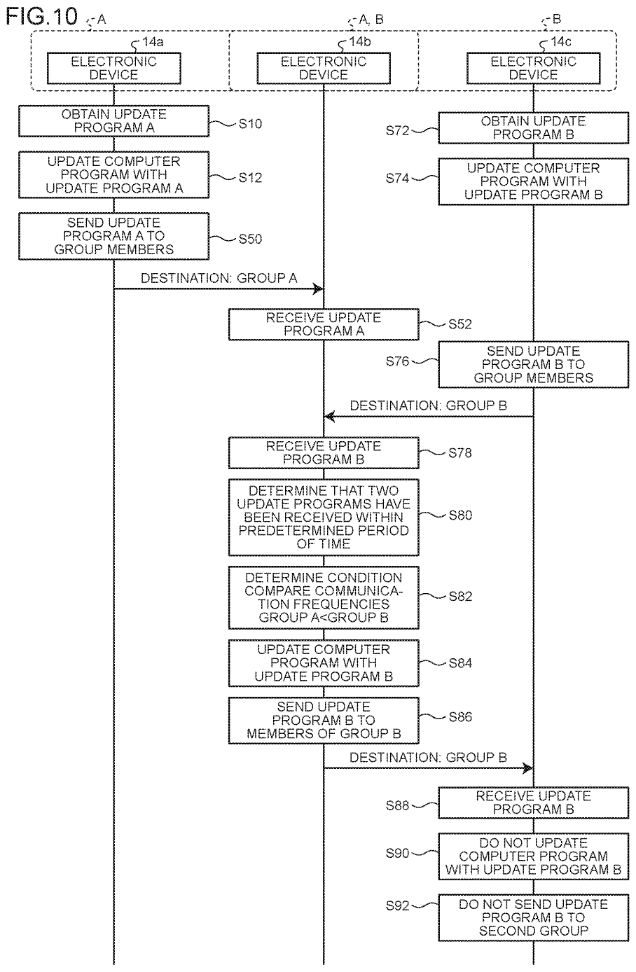

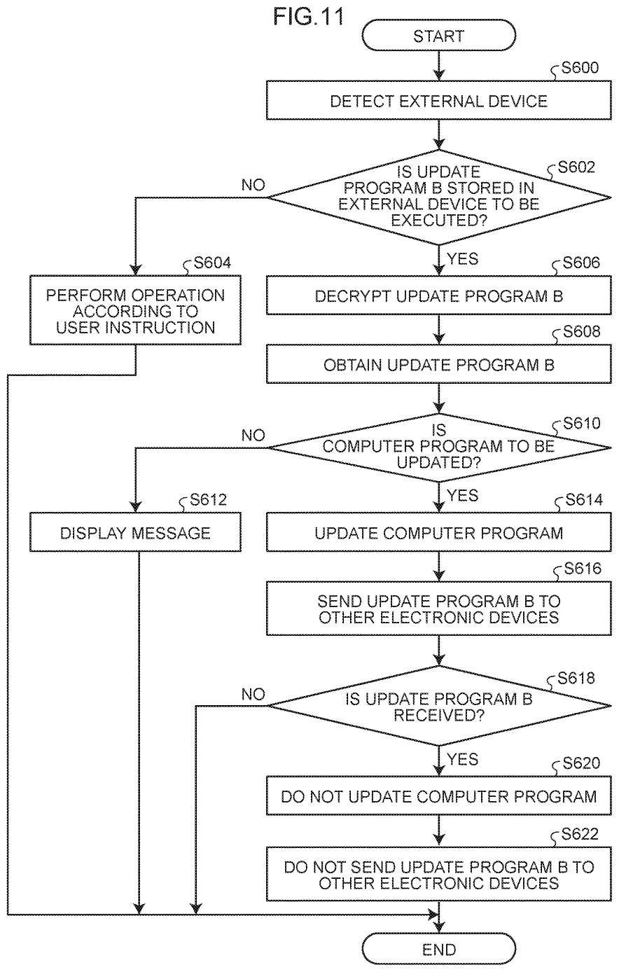

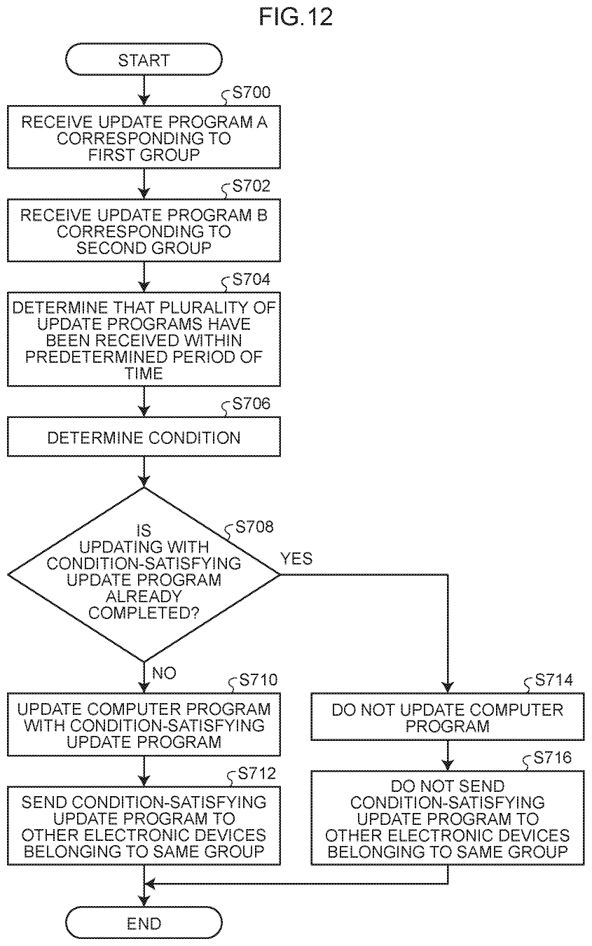

Explained below with reference to FIGS. 9 to 12 is a communication system 1B according to a third embodiment. FIG. 9 is a diagram for explaining a configuration of the communication system according to the third embodiment. FIG. 10 is a sequence diagram illustrating an example of a communication operation performed by an electronic device according to the third embodiment. FIG. 11 is a flowchart for explaining an exemplary flow of operations performed in the electronic device that obtains the update program according to the third embodiment. FIG. 12 is a flowchart for explaining an exemplary flow of operations performed in the electronic device that receives the update program according to the third embodiment. In the following explanation, the identical constituent elements to the communication systems according to the embodiments described above are referred to by the same reference numerals, and their detailed explanation is not given again. In the third embodiment, the fundamental configuration of the communication system 1B is identical to the communication system 1A according to the second embodiment. However, the third embodiment differs from the second embodiment in the way that the electronic device 14c obtains the update program from an external device 12B.

### Communication System

The communication system 1B includes management devices 10 and 10B, the external devices 12 and 12B, and the electronic devices 14a, 14b, and 14c. The communication system 1B differs from the communication system 1A illustrated in FIG. 6 in the way that the external devices 12 and 12B, in which the update programs for the electronic devices 14 is stored, are connected to the electronic devices 14a and 14c, respectively. The electronic device 14a obtains the update program A from the external device 12. The electronic device 14c obtains the update program B from the external device 12B. The electronic device 14a updates the computer program thereof with the update program A. The electronic device 14c updates the computer program thereof with the update program B. Then, the electronic device 14a sends the update program A to the group members (the other electronic devices) of the group A. The electronic device 14c sends the update program B to the group members (the other electronic devices) of the group B. Thus, the electronic device 14b receives the update programs A and B. Upon receiving a plurality of update programs, the electronic device 14b automatically updates its computer program with the update program that satisfies a certain condition. Thus, in the communication system 1B, as a result of updating the computer program in one electronic device, the computer programs in the other electronic devices across the groups can be updated automatically.

### Communication Operation

Explained below with reference to FIG. 10 is a communication operation performed in the electronic devices 14 according to the third embodiment.

With reference to FIG. 10, the electronic devices 14a and 14c have the external devices 12 connected thereto and obtain the corresponding update programs from the external devices 12 and 12B, respectively. The electronic device 14b receive the update programs using wireless communication.

The operations performed at Steps S10 and S12 and the operations performed at Steps S50 and S52 are identical to the corresponding operations illustrated in FIG. 8. Hence, that explanation is not given again.

The obtaining unit 42 of the electronic device 14c obtains the update program B from the external device 12B (Step S72). When the update program B is encrypted, the processing unit 40 of the electronic device 14c decrypts the update program B.

The updating unit 46 of the electronic device 14c updates its computer program with the update program B (Step S74). The updating unit 46 of the electronic device 14c overwrites its computer program with the update program B obtained by the obtaining unit 42, thereby resulting in automatic updating.

The communication unit 20 of the electronic device 14c sends the update program B to the other electronic devices (Step S76). More particularly, after the updating unit 46 of the electronic device 14c updates the computer program, the communication unit 20 of the electronic device 14c sends the update program to the group members (the electronic device 14b) of the group B.

The communication unit 20 of the electronic device 14b receives the update program B sent from the electronic device 14c (Step S78).

The determining unit 44 of the electronic device 14b determines that a plurality of update programs have been received within a predetermined period of time (Step S80). More particularly, it is determined that the update program B is received within a predetermined period of time since receiving the update program A.

The determining unit 44 of the electronic device 14b determines the condition (Step S82). For example, the determined condition indicates the communication count (frequency) for which the electronic device belonging to a plurality of groups has communicated with the electronic devices belonging to each group. Thus, the group in which the communication frequency was higher within a predetermined period of time in the past, for example, one week in the past is determined to match the condition. In the example illustrated in FIG. 12, the determining unit 44 of the electronic device 14b compares the communication frequencies thereof. For example, for example, the determining unit 44 of the electronic device 14b determines that the number of times for which the electronic device 14b communicates with the other electronic devices belonging to the group B is greater than the number of times for which the electronic device 14b communicates with the other electronic devices belonging to the group A; and accordingly selects the group B. At that time, the processing unit 40 of the electronic device b switches to the operation for enabling updating of the computer program of the electronic device 14b with the update program B that satisfies the condition. Herein, the predetermined condition is not limited to the communication frequency. Alternatively, for example, the fact that a plurality of update programs has been received can be displayed in the output unit 24, and the update program selected by the user by operating the operating unit 22 can be treated as the update program matching with the condition. Still alternatively, for example, the sequence of receiving the update programs can be treated as the determination condition. However, the condition is not limited to the examples given above.

The updating unit 46 of the electronic device 14b updates the computer program of the electronic device 14b with the update program B (Step S84). Based on the determination result obtained by the determining unit 44 of the electronic device 14b, the updating unit 46 of the electronic device 14b updates the computer program of the electronic device 14b with the update program B that is received by the communication unit 20 of the electronic device 14b from the electronic device 14c.

The communication unit 20 of the electronic device 14b sends the update program B (i.e., the update program satisfying the condition) to the other electronic devices belonging to the second group B (Step S86). More particularly, after the computer program of the electronic device 14b is updated, the communication unit 20 thereof sends the update program B to the group B, that is, to the electronic device 14c. Meanwhile, the update program A that was not used in updating the computer program can be sent to the electronic devices belonging to the group A.

The communication unit 20 of the electronic device 14c receives the update program B that is sent from the electronic device 14b (Step S88).

The updating unit 46 of the electronic device 14c does not update the computer program of the electronic device 14c (Step S90). Since the electronic device 14c has already updated its computer program with the update program B, it does not update its computer program with the update program B that is received from the electronic device 14b.

The communication unit 20 of the electronic device 14c does not send the update program B to the other electronic devices (Step S92). Since the computer program of the electronic device 14c has already been updated with the update program B, the communication unit 20 of the electronic device 14c does not send the update program B, which is received from the electronic device 14b, to the group members of the group B. Thus, regardless of whether an update program was used in updating the computer program, when the same update program as the previously-received update program is again received, the computer program is not updated with that same update program, and that update program is not sent to the other electronic devices.

### Operations Performed in Electronic Device

Given below is the explanation about the operations performed in the third embodiment.

Firstly, explained below with reference to FIG. 11 are the operations performed in the electronic device 14c that obtains the update program. The operations performed in the electronic device 14a are identical to the operations illustrated in FIG. 4. Hence, that explanation is not given again.

The processing unit 40 detects the connection with the external device 12B (Step S600).

The processing unit 40 determines whether to execute the update program B stored in the external device 12B (Step S602). More specifically, the processing unit 40 confirms with the user about whether to execute the update program B stored in the external device 12B. For example, the processing unit 40 displays, in the output unit 24, a message to confirm with the user about whether to execute the update program B.

When the update program B stored in the external device 12B is not to be executed, that is, when the user chooses not to execute the update program B (No at Step S602), the processing unit 40 performs an operation according to the user instruction (Step S604) and ends the operations regarding the update program B stored in the external device 12B. For example, the operation according to the user instruction indicates continuing with the operation that was being performed prior to the connection of the external device 12B.

When the update program B stored in the external device 12B is to be executed, that is, when the user chooses to execute the update program B (Yes at Step S602), the processing unit 40 decrypts the update program B (Step S606). When the update program B is not to be decrypted, the processing unit 40 performs the operation at Step S608.

The obtaining unit 42 obtains the update program B from the external device 12B (Step S608). Then, the obtaining unit 42 outputs the update program B to the memory unit 26 of the electronic device 14c.

The determining unit 44 determines whether to update the computer program of the electronic device 14c (Step S610). The determining unit 44 determines whether or not the update program B stored in the external device 12B is compatible, that is, whether or not the update program B stored in the external device 12B is valid, and accordingly determines whether to update the computer program of the electronic device 14c.

When it is determined not to update the computer program of the electronic device 14c (No at Step S610), the processing unit 40 generates a message indicating that the computer program of the electronic device 14c is not to be updated and displays the message in the output unit 24 (Step S612). That marks the end of the operations. For example, the processing unit 40 can generate a message such as “incompatible update program”. The case in which the computer program of the electronic device 14c is not to be updated is, for example, the case in which the update program B becomes invalid when decrypted.

When it is determined that the computer program of the electronic device 14c is to be updated (Yes at Step S610), the updating unit 46 overwrites the computer program of the electronic device 14c, thereby resulting in automatic updating (Step S614). At that time, the processing unit 40 implements the update function provided in the electronic device 14c.

The communication unit 20 sends the update program B to the other electronic devices using the wireless communication unit (Step S616). More specifically, the communication unit 20 reads the update program B from the memory unit 26 of the electronic device 14c and sends the update program B to the other electronic devices belonging to the same group B. The communication unit 20 sends the update program B addressed to the group ID stored in the other electronic devices. For example, the communication unit 20 sends the update program B to the electronic device 14b in which the stored group ID (the ID of the second group) is same as the group ID stored in the electronic device 14a. Alternatively, the communication unit 20 can send the update program B to the other electronic devices based on their terminal IDs.

The determining unit 44 determines whether the communication unit 20 of the electronic device 14c has received the update program B (Step S618). When the determining unit 44 determines that the communication unit 20 has not received the update program B (No at Step S618), it marks the end of the operations.

Even when the determining unit 44 determines that the communication unit 20 has received the update program B (Yes at Step S618), neither the updating unit 46 updates the computer program (Step S620) nor the communication unit 20 sends the update program B to the other electronic devices (Step S622). It marks the end of the operations.

Explained below with reference to FIG. 12 are the operations performed in the electronic device 14b that receives the update program.

In FIG. 12, the operation performed at Step S700 is identical to the operation performed at Step S200 illustrated in FIG. 5. Hence, that explanation is not given again.

The communication unit 20 receives the update program B corresponding to the group B (Step S702). The communication unit 20 receives the update program B that is sent from the electronic device 14c.

The determining unit 44 determines that a plurality of update programs is received within a predetermined period of time (Step S704). The determining unit 44 determines that the electronic device 14b has received a plurality of programs within a predetermined period of time. More particularly, the determining unit 44 determines that the communication unit 20 received the update program B within a predetermined period of time since receiving the update program A.

The determining unit 44 determines the condition (Step S706). The determining unit 44 determines the condition for deciding on the update program that, from among a plurality of received update programs, is to be used in the updating operation. Herein, the condition can indicate the communication frequency or the sequence of receiving the update programs. For example, the determining unit 44 determines the communication frequency regarding a plurality of groups to which the electronic device 14b belongs. Alternatively, the determining unit 44 determines which update program was received first by the electronic device 14b. Still alternatively, using the output unit 24, the determining unit 44 can make the user of the electronic device 14b to determine which update program is to be used in the updating operation. In the third embodiment, the determining unit 44 determines that, within a predetermined period of time in the past, the number of times for which the electronic device 14b communicates with the other electronic devices belonging to the group B is greater than the number of times for which the electronic device 14b communicates with the other electronic devices belonging to the group A; and determines that the group B matches the condition.

Except for the fact that the update program B satisfies the condition, the operation performed at Step S708 is identical to the operation performed at Step S202 illustrated in FIG. 5. Hence, that explanation is not given again.

The updating unit 46 updates the computer program of the electronic device 14b with the update program satisfying the condition (Step S710). The updating unit 46 overwrites the computer program of the electronic device 14b with the update program B satisfying the condition, thereby resulting in automatic updating. When the communication unit 20 of the electronic device 14b receives the update program A, which corresponds to the group A, and the update program B, which corresponds to the group B, within a predetermined period of time, the updating unit 46 updates the computer program of the electronic device 14b with the update program satisfying a predetermined condition. For example, the updating unit 46 updates the computer program with the update program corresponding to the group having the higher communication frequency. Alternatively, for example, the updating unit 46 performs updating with the update program received first by the communication unit 20. Still alternatively, for example, the updating unit 46 performs updating with the update program selected by the user. In the third embodiment, the updating unit 46 updates the computer program of the electronic device 14b with the update program B. At that time, the processing unit 40 implements the update function provided in the electronic device 14b.

The communication unit 20 sends the update program, which satisfies the condition, to the other electronic devices belonging to the same group (Step S712). More specifically, the communication unit 20 sends, from the memory unit 26, the update program satisfying the condition, that is, the update program used in updating the electronic device 14b (in the third embodiment, the update program B) to the other electronic devices belonging to the same group (in the third embodiment, the group B). Herein, the same group implies the group to which belongs the electronic device that sent the update program. The communication unit 20 selects the group B from a plurality of groups to which the electronic device 14b belongs, and sends the update program B to the group B (the electronic device 14c). That marks the end of the operations. The communication unit 20 sends the update program B based on the IDs stored in the electronic device 14b. For example, the electronic device 14c, in which the stored group ID (the ID of the group B) is same as the destination for the update program sent by the electronic device 14b, receives the update program B. Alternatively, the communication unit 20 can send the update program, which satisfies the condition, to the other devices based on the terminal IDs.

When the determining unit 44 determines that the communication unit 20 has already been updated with the update program satisfying the condition (Yes at Step S708), neither the updating unit 46 updates the computer program (Step S714) nor the communication unit 20 sends the update program satisfying the condition to the other electronic devices belonging to the same group (Step S716). That marks the end of the operations.

As explained above, in the third embodiment, the electronic device belonging to a plurality of groups (i.e., the electronic device 14b) receives a plurality of update programs. At that time, the electronic device 14b updates its computer program with the update program that satisfies a condition. After the computer program of the electronic device 14b is updated with the update program satisfying the condition, the electronic device 14b sends that update program only to those other electronic devices which belong to the group corresponding to that update program (i.e., only to the electronic device 14c). Meanwhile, the electronic device 14a is updated with the update program A. The electronic device 14a does not send the update program A to the electronic device 14c. However, the electronic device 14a sends the update program A to the electronic device 14b. That is, control can be performed to ensure that the update program A is sent only within the group A. The electronic device 14c is updated with the update program B. The electronic device 14c does not send the update program B to the electronic device 14a. However, the electronic device 14c sends the update program B to the electronic device 14b. That is, control can be performed to ensure that the update program B is sent only within the group B. Thus, it can be said that, when each external device 12 having the update program corresponding to a particular group stored therein is connected to only a single representative electronic device belonging to that group, the range over which each update program is to be sent can be controlled.

### Other Examples

In the embodiments described above, when a plurality of update programs is received, the update program used in the updating operation is sent to the other devices. For example, when the electronic device 14b receives the update programs A and B within a predetermined period of time and updates its computer program with the update program B; it sends the update program B, which is used in the updating operation, to the electronic device 14c. In another example, the electronic device 14b sends the update program A, which is not used in the updating operation, to the other electronic devices belonging to the group A. Thus, in the other example, when an update program is received from an electronic device belonging to the group A and when an update program is received from an electronic device belonging to the group B, the communication unit 20 of the electronic device 14b sends the update program not used in the updating operation to the group from which that update program was received.

As a result, in the group A, the other electronic devices that could not receive the update program A from the electronic device 14a can receive the update program A sent from the electronic device 14b, and can update their computer programs with the update program A.

Moreover, at the time of sending an update program to the other electronic devices, the concerned electronic device 14 can confirm with the other electronic devices, which belong to the same group, about whether updating with the update program is acceptable. With that, the update program can be sent to only those electronic devices which accepted updating their computer programs. When all electronic devices belonging to the same group reject the updating with the update program, the update program need not be sent. When the acceptance for the update program is confirmed, the user can be notified by displaying the acceptance status of the update program in the output unit 24 of the electronic device 14 that is attempting to send the update program.

Meanwhile, regarding the electronic device 14 that belongs to a plurality of groups and that receives a plurality of update programs, at the time of sending the update programs to the other electronic devices, the confirmation about the acceptance for the updating with the update program is taken on a group-by-group basis. As a result, only those electronic devices which belong to the group that accepted the updating of the computer program become able to update their computer programs.

Moreover, regarding the electronic device 14 belonging to a plurality of groups, a group from which the updating of the computer program is not accepted can be set. As a result, before receiving the update program sent from that group, the electronic device 14 can exclude that update program. That is, the electronic device 14 becomes able to receive only the required update program.

### Effects

The electronic device according to the embodiments includes: the determining unit 44 that determines whether or not to update the computer program of the electronic device 14; the updating unit 46 that, based on the determination result obtained by the determining unit 44, update the computer program with an update program; and the communication unit that performs communication with the other electronic devices belonging to the same group. When the determining unit 44 determines that the computer program has not been updated with the update program, the updating unit 46 updates the computer program either with the update program obtained by the communication unit 20 from the external device 12 or with the update program received by the communication unit 20; and, after the updating unit 46 updates the computer program, the communication unit 20 sends the update program to the other electronic devices belonging to the same group.

As a result, when a single electronic device is selected and its computer program is updated, the computer programs of the other electronic devices can also be updated automatically.

The electronic device according to the embodiments belongs to the groups A and B. When the communication unit 20 receives the update program A only from another electronic device belonging to the group A to which the concerned electronic device also belongs, the updating unit 46 updates the computer program with the received update program A; and the communication unit 20 sends the update program A to the other electronic devices belonging to the group B to which the concerned electronic device also belongs. As a result, the electronic devices belonging to the group B become able to receive the update program, which is common for the electronic devices, from the electronic device belonging to the group A. That is, even when there are different groups to which the electronic devices belong, the common update program can be communicated to the electronic devices belonging to different groups. As a result, merely by updating a single electronic device with the update program, the other electronic devices belonging to different groups also can receive that update program and update their computer programs. Thus, the computer programs of a plurality of electronic devices can be updated in an appropriate manner.

In the electronic device according to the embodiments, when the communication unit 20 receives, within a predetermined period of time, the update program A corresponding to the group A as well as the update program B corresponding to the group B, the updating unit updates the computer program with that update program which satisfies a predetermined condition. As a result, the electronic device 14 can update its computer program with the appropriate update program.

In the electronic device according to the embodiments, when the communication unit 20 receives the same update program as the previously-received update program, the communication unit 20 does not send that update program to the other electronic devices. As a result, the operation of updating the computer program with that update program gets completed in all electronic devices one by one, and the transfer of the update program is not repeated endlessly. Hence, the computer programs of a plurality of electronic devices can be updated in an appropriate manner.

An updating method for the electronic device according to the embodiments includes: determining whether or not to update the computer program of the electronic device 14; updating, based on the determination result obtained at the determining, the computer program with an update program; and communicating with the other electronic devices belonging to the same group and with the external device 12. In the determining, when it is determined that the computer program has not been updated with the update program, the updating includes updating the computer program either with the update program obtained at the communicating from the external device 12 or with the update program received by the communication unit 20. After the computer program is updated at the updating, the communicating includes sending the update program to the other electronic devices belonging to the same group.

As a result, when a single electronic device is selected and its computer program is updated, the computer programs of the other electronic devices can also be updated automatically. That is, the computer programs of a plurality of electronic devices can be updated in an appropriate manner.

The constituent elements of the devices illustrated in the drawings are merely conceptual, and need not be physically configured as illustrated. The constituent elements, as a whole or in part, can be separated or integrated either functionally or physically based on various types of loads or use conditions.

According to the application concerned, when a single electronic device is selected and its computer program is updated, the computer programs of the other electronic devices can also be updated automatically.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electronic device comprising:
a communication unit that performs communication with another electronic device belonging to a group or that performs communication with an external device to receive or transmit an update program;
a determining unit that determines whether or not to update a computer program of the electronic device; and
an updating unit that, when the communication unit receives the update program and the determining unit determines that the computer program has not been updated with the update program, the updating unit updates the computer program with the update program,
wherein the electronic device belongs to a first group and a second group, wherein
when the communication unit receives, within a predetermined period of time, the update program corresponding to the first group as well as the update program corresponding to the second group, the determining unit determines, based on a predetermined condition, an update program to be used for updating, and the updating unit updates the computer program based on the determination, and
after the updating unit updates the computer program, the communication unit sends the update program used for updating to the other electronic device belonging to the group corresponding to the update program used for updating.

2. The electronic device according to claim 1, wherein
the update program that satisfies the predetermined conditions is the update program corresponding to the group with which the communication unit has communicated more frequently.

3. The electronic device according to claim 1, wherein
when the communication unit receives the update program from another electronic device belonging to the first group to which the electronic device also belongs, the updating unit updates the computer program with the received update program, and
after the updating unit updates the computer program, the communication unit sends the update program to another electronic device belonging to a second group to which the electronic device also belongs.

4. The electronic device according to claim 1, wherein, when the communication unit receives an identical update program that is identical to the update program received in past, the communication unit does not send the identical update program to another electronic device.

5. An updating method for an electronic device, comprising:
communicating with another electronic device belonging to a group or with an external device to receive or transmit an update program;
determining whether or not to update a computer program of the electronic device; and
updating, when receiving the update program and the determining that the computer program has not been updated with the update program, updating the computer program with the update program,
wherein the electronic device belongs to a first group and a second group, wherein
when receiving, within a predetermined period of time, the update program corresponding to the first group as well as the update program corresponding to the second group, determining based on a predetermined condition, an update program to be used for updating, and updating the computer program based on the determination, and
after the computer program is updated at the updating, the communicating includes sending the update program used for updating to the other electronic device belonging to the group corresponding to the update program used for updating.
